(19) United States
(12) Patent Application Publication
(10) Pub. No.: US 2019/0036459 A1
(43) Pub. Date: Jan. 31, 2019

(54) FLYBACK POWER CONVERTERS INCLUDING ADAPTIVE CLAMP CIRCUITS FOR ADJUSTING RESONANT FREQUENCIES

(71) Applicant: Astec International Limited, Kwun Tong, Kowloon (HK)

(72) Inventors: Chunyu DING, Shenzhen (CN); Jun LIU, Shenzhen (CN); Qingfeng LIU, Guangdong (CN); Zhe LI, Shenzhen (CN)

(21) Appl. No.: 15/753,411

(22) PCT Filed: Apr. 28, 2017
(86) PCT No.: PCT/CN2017/082494

§ 371 Date: Feb. 19, 2018

(51) Int. Cl. H02M 3/335; H02M 1/08

(52) U.S. Cl. CPC H02M 3/33592; H02M 2001/0048; H02M 1/08

(57) ABSTRACT

A switch mode power supply includes a flyback power converter and a control circuit. The flyback power converter includes an input, an output, a transformer coupled between the input and the output, a power switch coupled between the input and the transformer, and a clamp circuit coupled between the input and the transformer. The clamp circuit includes a capacitor and a clamp switch coupled in series with the capacitor. The control circuit is configured to control the power switch and the clamp switch. The switch mode power supply further includes at least one additional capacitor coupled in parallel with the capacitor of the clamp circuit to facilitate selection of a combination of capacitors to adjust a resonant frequency of the clamp switch for optimizing efficiency of the power supply. Other examples switch mode power supplies and/or methods for adjusting a resonant frequency of flyback power converters are also disclosed.

### FIELD

The present disclosure relates to flyback power converters including adaptive clamp circuits for adjusting resonant frequencies.

### BACKGROUND

This section provides background information related to the present disclosure which is not necessarily prior art.

Power supplies having flyback converters are known. The flyback converters include transformers to provide isolation between inputs and outputs. Commonly, the flyback converters include clamps to limit voltages in the converters.

### SUMMARY

This section provides a general summary of the disclosure, and is not a comprehensive disclosure of its full scope or all of its features.

According to one aspect of the present disclosure, a switch mode power supply includes a flyback power converter and a control circuit. The converter includes an input, an output, a transformer coupled between the input and the output, a power switch coupled between the input and the transformer, and a clamp circuit coupled between the input and the transformer. The clamp circuit includes a capacitor and a clamp switch coupled in series with the capacitor. The control circuit is configured to control the power switch and the clamp switch. The switch mode power supply further includes at least one additional capacitor coupled in parallel with the capacitor of the clamp circuit to facilitate selection of a combination of capacitors to adjust a resonant frequency of the clamp switch for optimizing efficiency of the power supply.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a switch mode power supply including a flyback power converter having an active clamp, and a control circuit according to one example embodiment of the present disclosure.

FIG. 2 is an electrical schematic of a switch mode power supply including a flyback power converter having an active clamp with two capacitors coupled together in parallel according to another example embodiment.

FIG. 3 is a graph plotting the change in capacitance of the capacitors of FIG. 2 against a DC bias voltage.

FIG. 4 is an electrical schematic of a switch mode power supply including a flyback power converter having an active clamp with three capacitors coupled together in parallel according to yet another example embodiment.

FIG. 5 is an electrical schematic of a switch mode power supply including a flyback power converter and a control circuit according to another example embodiment.

Corresponding reference numerals indicate corresponding parts and/or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

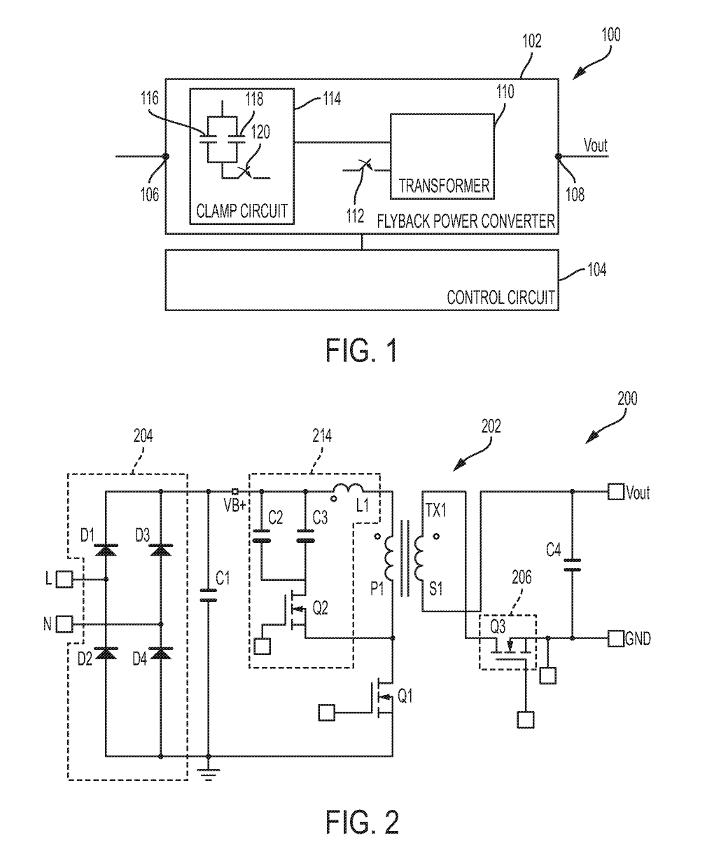

A switch mode power supply according to one example embodiment of the present disclosure is illustrated in FIG. 1 and indicated generally by reference number 100. As shown in FIG. 1, the switch mode power supply 100 includes a flyback power converter 102 and a control circuit 104. The flyback power converter 102 includes an input 106, an output 108, a transformer 110 coupled between the input 106 and the output 108, a power switch 112 coupled between the input 106 and the transformer 110, and a clamp circuit 114 coupled between input 106 and the transformer 110. As shown, the clamp circuit 114 includes two capacitors 116, 118 coupled in parallel and a clamp switch 120 coupled in series with the two capacitors 116, 118. The control circuit 104 controls the power switch 112 and the clamp switch 120. As further explained below, the capacitors 116, 118 may facilitate selection of a combination of capacitors to adjust a resonant frequency of the clamp switch 120 for optimizing efficiency of the power supply 100.

For example, the power supply 100 (e.g., the power switch 112) may provide a range of output voltages depending on, for example, a particular load coupled to the power supply 100. Components such as the capacitors 116, 118 may be selected based on a particular output voltage Vout so that the clamp switch 120 operates at a resonant frequency when the power supply 100 provides that voltage. This may optimize power supply efficiency.

If, however, a different output voltage Vout is required and one or more components in the power supply 100 remain the same, the efficiency of the power supply 100 may decrease. For example, the capacitors 116, 118 may be selected to optimize efficiency at a maximum output voltage (e.g., about 20V, etc.). If a lower output voltage Vout is required, the transformer's magnetic reset time may increase causing a turn off (Toff) time of the clamp switch 120 to increase. This in turn forces the clamp switch 120 to operate at a varying switching frequency substantially different than the resonant frequency causing power supply efficiency to decrease.

However, if the combination of capacitors 116, 118 are altered appropriately (as further explained below), the resonant frequency may be adjusted to adapt to the change in the turn off (Toff) time of the clamp switch 120. For example, the combination of the capacitors 116, 118 may be altered causing the resonant frequency to adjust to the increase in the turn off (Toff) time. In such examples, the resonant frequency may align (again) with the varying switching frequency of the clamp switch 120. In turn, the power supply efficiency may increase and/or remain steady (and not decrease) when a different output voltage Vout is desired.

This flexibility may allow a user to produce a generic power supply without installing a particular combination of clamp circuit capacitors. The generic power supply may be capable of accommodating a wide range of possible output voltages. Once an expected particular output voltage is determined, an appropriate combination of clamp circuit capacitors may be selected (based on that output voltage) and installed in the power supply to adjust a resonant frequency of the clamp switch 120 for optimizing efficiency of the power supply at that particular output voltage.

The combination of capacitors 116, 118 may be altered in various optional ways. For example, the combination of capacitors 116, 118 may be adjusted by coupling one or more additional capacitors to the capacitors 116, 118. In other embodiments, the combination of capacitors 116, 118 may be adjusted by replacing at least one of the capacitors with another capacitor. For example, and as further explained below, one capacitor may be replaced with another capacitor having a different capacitor rating (e.g., capacitance, DC voltage rating, etc.).

In other embodiments, the combination of capacitors 116, 118 coupled in parallel may be altered by adjusting a capacitance of at least one of the capacitors. For example, at least one of the capacitors 116, 118 may include a variable capacitor capable of varying its capacitance without physically removing the capacitor. The variable capacitor may have its capacitance adjusted mechanically and/or electronically, if desired.

The resulting combination of capacitors 116, 118 may include two or more capacitors having the same or different capacitor ratings. For example, and in some preferred embodiments, the capacitors 116, 118 have different capacitor ratings. In such examples, the capacitor 116 may have a different capacitance, DC voltage rating, etc. than the capacitor 118. In other embodiments, the capacitors 116, 118 may have different capacitances but the same DC voltage ratings, different DC voltage ratings but the same capacitances, etc. Alternatively, the capacitors 116, 118 may have substantially the same capacitor ratings if desired.

As shown in FIG. 1, the clamp circuit 114 includes at least one active component such as the clamp switch 120. As such, the flyback power converter 102 may be considered an active clamp flyback power converter. The clamp switch 120 may be controlled in any suitable manner including, for example, based on a sensed parameter on the secondary side of the transformer 110 (as further explained below), the primary side of the transformer 110, etc.

FIG. 2 illustrates another switch mode power supply 200 including a flyback power converter 202, an input terminal L for receiving an AC input voltage, an output terminal for coupling to a load, and a clamp circuit 214. The power supply 200 provides a DC output voltage Vout at the output terminal. Similar to the flyback power converter 102 of FIG. 1, the flyback power converter 202 includes a transformer TX1 coupled between the input terminal L and the output terminal, and a power switch Q1 coupled between the input terminal L and the transformer TX1. In particular, the power switch Q1 is coupled to a primary winding P1 of the transformer TX1.

As shown in FIG. 2, the power supply 200 includes various optional rectification circuits and filters. For example, the power supply 200 includes a filter capacitor C1 coupled between the input terminal L and the clamp circuit 214 and a filter capacitor C4 coupled between the output terminal and the transformer TX1. Additionally, the power supply 200 includes a rectification circuit 204 coupled between the input terminal L and the filter capacitor C1. As shown, the rectification circuit 204 includes a diode bridge rectifier having four diodes D1, D2, D3, D4 that rectifies AC power received at the input terminal L into DC power. In other embodiments, other suitable rectification circuits may be employed if desired.

Additionally, and as shown in FIG. 2, the flyback power converter 202 includes a rectification circuit 206 coupled between the transformer TX1 and the output terminal. In particular, the rectification circuit 206 is coupled between a secondary winding S1 of the transformer TX1 and the output terminal. In the particular example of FIG. 2, the rectification circuit 206 includes a synchronous rectifier (e.g., a MOSFET Q3) coupled between the transformer TX1 and the output terminal. In some embodiments, and as further explained, the MOSFET Q3 and the clamp switch Q2 may be controlled such that the MOSFET Q3 and the clamp switch Q2 turn on and turn off substantially simultaneously. In other embodiments, the rectification circuit 206 may include another suitable rectifier if desired.

The clamp circuit 214 of FIG. 2 is substantially similar to the clamp circuit 114 of FIG. 1. For example, and as shown in FIG. 2, the clamp circuit 214 includes two capacitors C2, C3 coupled together in parallel and a clamp switch Q2 coupled in series with the parallel coupled capacitors C2, C3. Additionally, the clamp circuit 214 includes an inductor L1 coupled between the capacitors C2, C3 and the primary winding P1 of the transformer TX1.

In some embodiments, the clamp circuit 214 may include more than two capacitors. For example, FIG. 4 illustrates another switch mode power supply 400 including the flyback power converter 202 of FIG. 2 and a clamp circuit 414 that is substantially similar to the clamp circuit 214 of FIG. 2. The clamp circuit 414 of FIG. 4, however, includes three capacitors C2, C3, C5 coupled together in parallel, and the clamp switch Q2 coupled in series with the parallel coupled capacitors C2, C3, C5.

Referring back to FIG. 2, the capacitors C2, C3 may be coupled to a terminal of the clamp switch Q2 in which current flows through. As such, the capacitors C2, C3 are not coupled to a control terminal (e.g., a gate terminal, etc.) of the clamp switch Q2. For example, the clamp switch Q2 of FIG. 2 is an N-channel MOSFET having a source terminal coupled to a reference voltage (e.g., ground), a drain terminal coupled to the parallel coupled capacitors C2, C3, and a gate terminal coupled to a control circuit (not shown). In other examples, the clamp switch Q2 may be another suitable switch (e.g., a P-channel MOSFET, a FET, etc.).

As shown in FIG. 2, the clamp circuit 214 is coupled across the primary winding P1 of the transformer TX1. In particular, the capacitors C2, C3 are coupled to one end of the transformer's primary winding P1 (via the inductor L1) and the clamp switch Q2 is coupled to another opposing end of the transformer's primary winding P1.

The resonant components in the flyback power converter 202 may create a resonance tank circuit. In the particular example of FIG. 2, the capacitors C2, C3, the inductor L1, and a magnetizing inductance (Lm) of the transformer TX1 create an LLC tank circuit. This resonance tank circuit may assist in soft switching (e.g., zero voltage switching and zero current switching) of one or more of the switches Q1, Q2, Q3 in the flyback power converter 202.

For example, when the power switch Q1 turns on, energy is stored in the magnetizing inductance (Lm) of the transformer TX1. During this time, the clamp switch Q2 and the synchronous rectifier Q3 are off. As some later time, the power switch Q1 turns off and resonant current generated by the LLC tank circuit flows through a body diode of the clamp switch Q2. Once the voltage across the clamp switch Q2 falls to zero, the clamp switch Q2 and the synchronous rectifier Q3 may turn on. During this time, energy stored in the magnetizing inductance (Lm) is transferred to the secondary side of the transformer TX1 and to the output Vout. When the current flowing through the rectifier Q3 falls to zero, the rectifier Q3 and the clamp switch Q2 turn off. Resonant current then flows through a body diode of power switch Q1. Once the voltage across the power switch Q1 falls to zero, the power switch Q1 may again turn on.

As explained above, when a change in the output voltage Vout is required, the clamp switch Q2 may operate at a varying frequency substantially different than the resonant frequency causing power supply efficiency to decrease. For example, and in accordance with one exemplary embodiment (Example 1), the turn on (Ton) time of the clamp switch Q2 may be 0.75 μs, the inductance of inductor L1 may be 2.5 μH, the turns ratio (n) of the transformer TX1 may be 6, and the input bulk capacitor voltage VB (as shown in FIG. 2) may be 300V.

Additionally, in this exemplary embodiment, the capacitor C2 may be a 500V/82 nF capacitor, and the capacitor C3 may be a 250V/200 nF capacitor. The capacitors C2, C3 may be, for example, GRM (X7R) series capacitors and/or other suitable types of capacitors (e.g., GRM (X8R) series capacitors, GRM (X5R) series capacitors, GRM (X7S) series capacitors, GR3 series capacitors, etc.). In such examples, when the output voltage Vout is 20V, a voltage Vc biasing the capacitors C2, C3 is 120V (i.e., Vout*n=Vc). The actual capacitance of the capacitors C2, C3 may change based on numerous factors including, for example, a biasing voltage, etc.

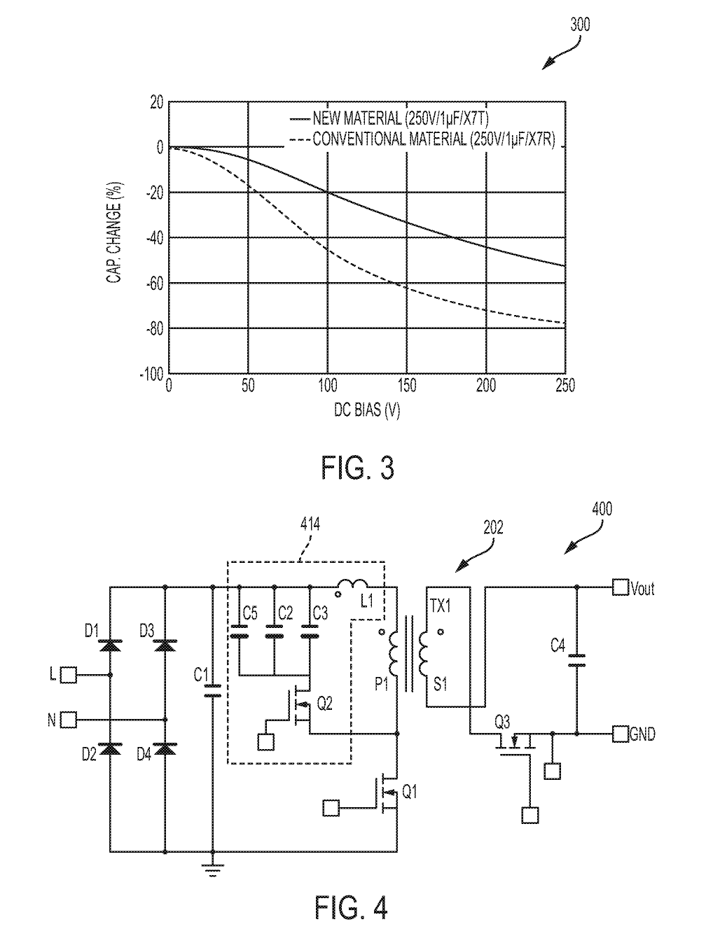

For example, a DC bias curve may be used to determine a change in capacitance for particular capacitors. That change in capacitance may then be used to determine an actual capacitance of the capacitors. For example, the actual capacitance of the capacitors C2, C3 in resonant may be determined from a DC bias curve for the capacitors (e.g., similar to the example DC bias curve 300 of FIG. 3). In this example, because the voltage Vc biasing the capacitors C2, C3 is 120V, the change in capacitance of the capacitors C2, C3 can be determined. Based on that change in capacitance, the actual capacitances of the capacitors C2, C3 in resonant for this particular example is determined to be 65.6 nF (i.e., C2=0.8×82 nF) and 80 nF (i.e., C3=0.4×200 nF), respectively.

Using the actual capacitances of the capacitor C2 (i.e., 65.6 nF) and the capacitor C3 (i.e., 80 nF), the resonant frequency can be determined with equation (1) below. In such examples, the resonant frequency (f) is equal to 2.638×10⁵ Hz.

$$Resonant Frequency ( f ) = \frac{1}{2 π \sqrt{( C 2 - C 3 ) \times L 1}} \qquad ( 1 )$$

As such, the resonant cycle or period (T) for this resonant frequency is equal to 3.791×10⁻⁶ s, as determined by equation (2) below.

$$Period ( T ) = \frac{1}{f} \qquad ( 2 )$$

The period (T), the turn on (Ton) time of the clamp switch Q2, the voltage VB, and the output voltage Vout may then be used to determine the turn off (Toff) time of the clamp switch Q2, as shown by equation (3) below. In this particular example, the turn off (Toff) time of the clamp switch Q2 is equal to 1.875×10⁻⁶ s.

$$Toff = \frac{Ton \times VB}{n \times Vout} \qquad ( 3 )$$

A turn off ratio relative to the period (T) of the clamp switch Q2 may then be determined using equation (4) below. In this particular example, the turn off ratio is 0.989. Put another way, the turn off (Toff) time of the clamp switch Q2 is substantially the same as one half the resonant cycle (T). This ratio (e.g., near a value of one) indicates a close proximity to the resonance cycle when the selected capacitors C2, C3 are employed and a 20V output is provided. As such, the clamp switch Q2 is operated near a resonant frequency thereby optimizing converter efficiency, as explained above.

$$Turn Off Ratio = \frac{Toff}{\frac{T}{2}} \qquad ( 4 )$$

As shown below, this turn off ratio may change (and in cases change significantly) given a change in the output voltage. For example, if the output voltage Vout is now 5V, the voltage Vc on the same capacitors C2, C3 is now equal to 30V (i.e., Vc=Vout×n=5V×6). Based on the DC bias curve 300 of FIG. 3, the actual capacitances of the capacitors C2, C3 in resonant is 76.26 nF (i.e., 0.93×82 nF) and 186 nF (i.e., 0.93×200 nF), respectively.

The actual capacitances of the capacitor C2 (i.e., 76.26 nF) and the capacitor C3 (i.e., 186 nF) are then used to determine the resonant frequency (f), as shown in equation (1) above. In this example, the resonant frequency (f) is 1.966×10⁵ Hz. Based on this resonant frequency (f), the period (T) is 5.088×10⁻⁶ s, as determined by equation (2) above. After which, the turn off (Toff) time of the clamp switch Q2 is determined based on the period (T) (see equation (3) above). In this example, the turn off (Toff) time is 7.5×10⁻⁶ s. Thus, it can be seen that the turn off (Toff) time significantly varies (e.g., from 1.875×10⁻⁶ s to 7.5×10⁻⁶ s) when the output voltage Vout changes from 20V to 5V.

A turn off ratio relative to this different period (T) is then determined using equation (4) above. In this particular example, the turn off ratio is 2.948. Thus, the turn off (Toff) time of the clamp switch Q2 is substantially greater than one half the resonant cycle (T). As such, when the output voltage Vout decreases, the clamp switch Q2 operates at a varying frequency substantially different than the resonant frequency causing the converter efficiency to decrease.

In accordance with another exemplary embodiment (Example 2), the turn on (Ton) time of the clamp switch Q2, the inductance of inductor L1, the turns ratio (n) of the transformer TX1, and the voltage VB are the same values as outlined above in Example 1. However, the capacitors C2, C3 are 500V/82 nF capacitors. In this example, when the output voltage Vout is 20V, the voltage Vc on the capacitors C2, C3 is again equal to 120V (i.e., Vout*n). Therefore, based on the DC bias curve (e.g., similar to the example DC bias curve 300 of FIG. 3), the actual capacitance of the capacitors C2, C3 in resonant is determined to equal 65.6 nF (C2, C3=0.8×82 nF), as explained above.

In this particular example, the resonant frequency (f) equals 2.779×10⁵ Hz, the period (T) for this resonant frequency equals 3.598×10⁻⁶ s, the turn off (Toff) time of the clamp switch Q2 equals 1.875×10⁻⁶ s, and the turn off ratio relative to this period (T) equals 1.042, when using equations (1)-(4) above. Thus, and as explained above, the turn off ratio (which is near one) indicates a close proximity to the resonance cycle when the selected capacitors C2, C3 are employed and a 20V output is provided. As such, the clamp switch Q2 is operated near a resonant frequency thereby optimizing converter efficiency, as explained above.

When the output voltage Vout changes to 5V, the voltage Vc on the capacitors C2, C3 is equal to 30V. Based on the DC bias curve (e.g., similar to the example DC bias curve 300 of FIG. 3), the actual capacitance of the capacitors C2, C3 in resonant is determined to equal 76.26 nF (C2, C3=0.93×82 nF), as explained above.

Based on this decreased output voltage Vout, the resonant frequency (f) is 2.577×10⁵ Hz, the period (T) for this resonant frequency is 3.88×10⁻⁶ s, the turn off (Toff) time of the clamp switch Q2 is 7.5×10⁻⁶ s, and the turn off ratio relative to this different period (T) is 3.866, when using equations (1)-(4) above. Thus, and as explained above, this turn off ratio is not in close proximity to the resonance cycle when the selected capacitors C2, C3 are employed and a 5V output is provided. As such, the clamp switch Q2 is operated at a varying frequency substantially different than a resonant frequency causing converter efficiency to decrease, as explained above.

From the examples above, it can be seen that a change in the actual capacitance of the capacitors causes the resonant frequency (f) to adjust. In the examples above, this is caused by providing different output voltages (e.g., 5V, 20V, etc.) which in turn forces the voltages Vc on the capacitors to change. However, the actual capacitance of the capacitors may also be altered by adjusting the capacitance of the group of capacitors C2, C3. As explained above, the actual capacitance (and therefore the resonant frequency) of the group of capacitors C2, C3 may be adjusted by replacing capacitor(s) with new capacitor(s) having different capacitance(s), replacing capacitor(s) with new capacitor(s) having different DC bias curves, changing a capacitance of the capacitor(s), adding capacitor(s) to the group of capacitors C2, C3, etc. Thus, the resonant frequency may be adjusted to substantially align with the current value of the varying switching frequency of the clamp switch Q2.

As shown in Table 1 below, the efficiency of the flyback power converter 202 having an output voltage Vout of about 5V is calculated for Examples 1 and 2 above. As shown, when the capacitors C2, C3 have different capacitor ratings (as in Example 1) such as capacitances, voltage ratings, etc., the converter efficiency is increased compared to when the capacitors C2, C3 have the same capacitor ratings. Thus, in this particular example, it is preferred to have capacitors C2, C3 with different capacitor ratings.

TABLE 1

| | Example 2: C2 = 500 V/82 nF | | | | Example 1: C2 = 500 V/82 nF | | | | |
|---|---|---|---|---|---|---|---|---|---|
| | C3 = 500 V/82 nF | | | | C3 = 250 V/200 nF | | | | |
| Vin | Vo | Io | Pin | Eff. | Vo | Io | Pin | Eff. | Δ Eff. |
| 230 | 4.808 | 2.076 | 12.18 | 81.95% | 4.808 | 2.076 | 12.04 | 82.90% | 0.95% |
| 115 | 4.808 | 2.076 | 11.82 | 84.45% | 4.808 | 2.076 | 11.72 | 85.17% | 0.72% |

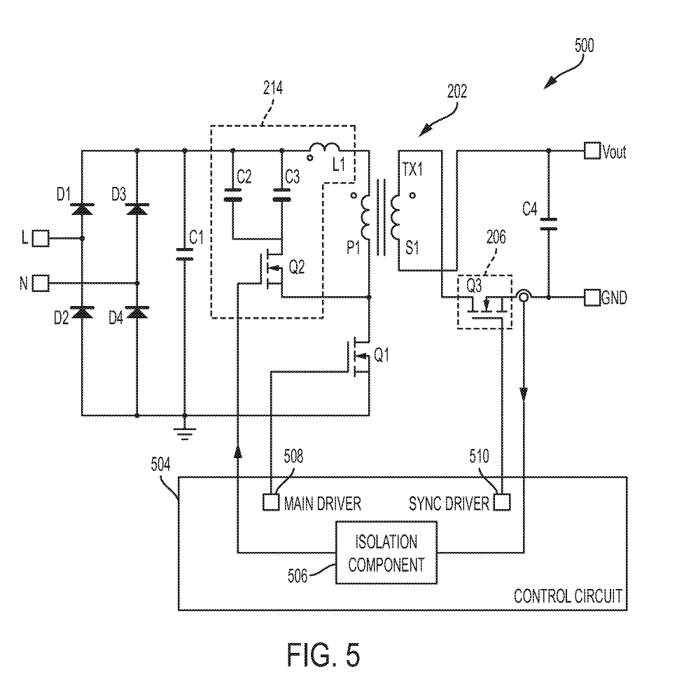

FIG. 5 illustrates another switch mode power supply 500 substantially similar to the power supply 200 of FIG. 2. For example, and similar to the power supply 200 of FIG. 2, the power supply 500 of FIG. 5 includes the flyback power converter 202, the rectification circuit 206, and the clamp circuit 214 of FIG. 2. The power supply 500 also includes a control circuit 504 for controlling the power switch Q1 of the flyback power converter 202, the clamp switch Q2 of the clamp circuit 214, and the synchronous rectifier Q3 of the rectification circuit 206.

In the particular example of FIG. 5, the control circuit 504 includes drivers for controlling one or more of the switches. For example, the control circuit 504 includes a main driver 508 for controlling the power switch Q1 and a sync driver 510 for controlling the synchronous rectifier Q3. These drivers 508, 510 may control their respective switches Q1, Q3 based on one or more sensed parameters (not shown), etc. In other embodiments, the switches Q1, Q3 may be controlled in another suitable manner.

In some embodiments, the control circuit 504 may control the synchronous rectifier Q3 such that the synchronous rectifier Q3 and the clamp switch Q2 turn on and turn off substantially simultaneously. For example, the control circuit 504 may sense a parameter on a secondary side of the transformer TX1 and then provide control signals to the clamp switch Q2 based on that sensed parameter. In particular, and as shown in FIG. 5, the sensed parameter on the secondary side of the transformer TX1 is a rectified current flowing through the synchronous rectifier Q3. In other embodiments, the control circuit 504 may sense, utilize, etc. another suitable parameter such as, for example, a secondary side voltage, a signal from the driver 510, etc. to control the clamp switch Q2.

The rectified current signal may be passed through an isolation component 506 (e.g., an optocoupler, a transformer, etc.) in the control circuit 504, and then provided to the clamp switch Q2. This allows the control circuit 504 to control the clamp switch Q2 synchronously with the synchronous rectifier Q3, as explained above.

The control circuits disclosed herein may include an analog control circuit, a digital control circuit (e.g., a digital signal controller (DSC), a digital signal processor (DSP), etc.), or a hybrid control circuit (e.g., a digital control unit and an analog circuit). Additionally, the entire control circuit, some of the control circuit, or none of the control circuit may be an integrated circuit (IC).

The switches disclosed herein may include transistors (e.g., MOSFETs as shown in FIGS. 2, 4 and 5, etc.) and/or another suitable switching device. If MOSFET(s) are employed, the MOSFET(s) may include N-type MOSFET(s) and/or a P-type MOSFET(s).

The power supplies disclosed herein may be any suitable power supply (e.g., an AC-DC power supply or a DC-DC power supply) including at least one flyback power converter and at least one active clamping circuit. Switches in the power supplies may be controlled so that the power supplies can provide a wide range of output voltages (e.g. a varying output voltage). For example, the power supplies may provide an output voltage between about 5V and about 20V. In some embodiments, the power supplies may include USB type C adapters and/or other suitable output adapters for coupling to loads.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. In a switch mode power supply comprising a flyback power converter including an input, an output, a transformer coupled between the input and the output, a power switch coupled between the input and the transformer, and a clamp circuit coupled between the input and the transformer, the clamp circuit including a capacitor and a clamp switch coupled in series with the capacitor, and a control circuit configured to control the power switch and the clamp switch, the switch mode power supply further comprising at least one additional capacitor coupled in parallel with the capacitor of the clamp circuit to facilitate selection of a combination of capacitors to adjust a resonant frequency of the clamp switch for optimizing efficiency of the switch mode power supply.

2. The switch mode power supply of claim 1 wherein the capacitor of the clamp circuit and the at least one additional capacitor have different capacitor ratings.

3. The switch mode power supply of claim 2 wherein the different capacitor ratings include different capacitances.

4. The switch mode power supply of claim 2 wherein the different capacitor ratings include different DC voltage ratings.

5. The switch mode power supply of claim 1 wherein the at least one additional capacitor includes one capacitor coupled in parallel with the capacitor of the clamp circuit.

6. The switch mode power supply of claim 1 wherein the at least one additional capacitor coupled in parallel with the capacitor of the clamp circuit is selected based on an output voltage of the switch mode power supply.

7. The switch mode power supply of claim 1 wherein the transformer includes at least one primary winding and at least one secondary winding, and wherein the clamp circuit is coupled across the at least one primary winding of the transformer.

8. The switch mode power supply of claim 7 wherein the clamp circuit includes an inductor coupled between the capacitor of the clamp circuit and the at least one primary winding of the transformer.

9. The switch mode power supply of claim 1 wherein the transformer includes at least one primary winding and at least one secondary winding, and wherein the flyback power converter includes a rectification circuit coupled between the at least one secondary winding of the transformer and the output.

10. The switch mode power supply of claim 9 wherein the control circuit is configured to sense a parameter on a secondary side of the transformer and control the clamp switch based on the sensed parameter.

11. The switch mode power supply of claim 10 wherein the sensed parameter includes a sensed rectified current.

12. The switch mode power supply of claim 9 wherein the rectification circuit includes a synchronous rectifier.

13. The switch mode power supply of claim 12 wherein the control circuit is configured to control the synchronous rectifier and the clamp switch to turn on and turn off substantially simultaneously.
